(19) United States
(12) Patent Application Publication
(10) Pub. No.: US 2013/0133421 A1
(43) Pub. Date: May 30, 2013

(54) DIFFERENTIAL ALTITUDE MEASURMENT

(71) Applicant: Daniel A. Katz, Kiryat Ono (IL)

(72) Inventor: Daniel A. Katz, Kiryat Ono (IL)

(73) Assignee: Daniel A. Katz, Kiryat Ono (IL)

(21) Appl. No.: 13/307,113

(22) Filed: Nov. 30, 2011

(51) Int. Cl. G01L 7/00; G01P 15/18; G01S 19/31

(52) U.S. Cl. 73/490; 342/357.71; 73/384

(57) ABSTRACT

Altitude measuring devices such as barometers typically provide good differential reading yet poor absolute reading, mainly depending on dynamic weather conditions. Placed at the same altitude but on different days, a barometer based altimeter might show different altitude reading. Thus, such altimeters, when used for navigation by pilots and mountaineers, for example, require manual and timely calibration. The present invention discloses a method for automatic calibration of altitude measurement devices, such as barometers, in order to achieve good absolute readings yet avoid the present manual calibration. This method is particularly useful for indoors navigation.

### BACKGROUND OF THE INVENTION

The present invention relates to the art of digital communications, particularly to radio navigation.

Global Navigation Satellite Systems (GNSS), such as the US GPS and the Russian GLONASS, are very effective and popular means of positioning and navigation. Basically, a GNSS receiver is configured to determine its (x, y, z) coordinates, according to a pre defined geographical coordinate system known in the art as ECEF (Earth Center Earth Fixed).

The ECEF coordinate system rotates with the Earth and has its origin at the earth centre. The X axis passes through the equator (latitude 0°) at the prime meridian (longitude 0°, on Greenwich). The Z axis passes through the North Pole, substantially aligned with the instantaneous Earth rotational axis.

FIG. 1 depicts the ECEF Geographic Coordinate System.

However, GNSSs are usually designed to operate in open spaces, where there is substantially a line of sight between the receiver and the satellites. Indoors positioning is very problematic for GNSSs, due to attenuation and multi path which the satellites signals are subject to, mainly related to the relatively high frequency of the signals broadcast by the satellites, typically in L-band.

The present art suggests then, for indoors positioning, replacing GNSS satellites with pseudolites. Pseudolites (pseudo-satellites) are most often small transceivers emulating GNSS-alike signals, detectable by standard GNSS receivers. Yet, even pseudolite navigation indoors suffers from multipath, and from poor signal penetration through walls and floors, i.e. requires heavy infrastructure.

There are other radio navigation methods known in the art for indoors positioning based on signals broadcast by reference stations. Such reference stations are, for example, mobile Base Stations (BS) or wireless LAN Access Points (AP). This way, Trilateration can be employed, measuring a signal Time of Arrival (TOA), or triangulation, measuring a signal Angle of Arrival (AOA), wherein the signal is broadcast by these reference stations, and wherein the position of said stations is known in advance or explicitly reported or may be derived from the signals that they broadcast.

Employing Trilateration, a reference beacon, such as BS or AP or pseudolite, may broadcast its own position, and time instant of transmission, so a mobile device could measure the TOA of the signal, and accordingly determine its distance from said reference beacon, similarly to GPS positioning.

As a person skilled in the art probably appreciates at this point, positioning indoors is not necessarily done uniquely by a GNSS receiver, but rather by a mobile device comprising several means to assist in determining self position, such as connectivity to cellular and wireless LAN networks, as well as a GNSS receiver to detect pseudolites.

In order to fix a position via Trilateration, usually four signals from four different reference stations are required, yet typically, cellular and WLAN networks are not deployed so redundantly since differently than GPS, access to one BS or one AP is enough for communications.

Furthermore, the Trilateration accuracy is very sensible to the geometry of the reference stations. As well known in the art, a poor geometry (i.e. low volume formed by the positions of the satellites and user) causes poor (high) DOP (dilution of position). In this context, cellular/WLAN Trilateration is expected to suffer worse VDOP (Vertical DOP) than GPS, due to the typically common level deployment of base stations. This poor nature of cellular/WLAN infrastructure particularly downgrades the height (or elevation or altitude) accuracy, in a way that such methods could hardly distinguish between near floors in a high building.

Another present art method to cope with indoors navigation is Dead Reckoning. Dead reckoning (DR) is a method of navigation, estimating the current position based on a previously determined position (fix), and measuring distance and direction of advancing from that position. In particular, inertial sensors are used to determine the acceleration (in two or three directions), from which the distance and direction of movement can be derived.

Though big and expensive Inertial Navigation Systems (INS) can still be found in submarines and airplanes (particularly optical INS), small and low cost accelerometers can be found nowadays in smart phones.

Another sensor, particularly used for navigation in airplanes, is the altimeter, recently getting small and low cost enough to be embedded in smart phones and wrist watches. The altimeter, typically implemented by a barometer, measures the atmospheric pressure, and converts the pressure into altitude, as the greater the altitude the lower the pressure is. When a barometer is supplied with a nonlinear calibration so as to indicate altitude, the instrument is called a pressure altimeter or barometric altimeter. A pressure altimeter is the altimeter found in most aircraft. Hikers and mountain climbers use wrist-mounted or hand-held altimeters, in addition to other navigational tools such as a map, magnetic compass, or GPS receiver. An altimeter is often more accurate than a GPS receiver for measuring altitude, e.g. deep in a canyon, or when all available satellites are near the horizon. Furthermore, when GPS signals are not available, as indoors, an altimeter can be very useful.

One significant drawback of altimeters is that the barometric pressure changes with the weather, so pilots and hikers must periodically recalibrate their altimeters when reach a known altitude, such as a trail junction or peak marked on a topographical map for hikers and airport height for pilots.

The altitude (z) above mean sea level at a point where the pressure is P is:

z=c T log(P₀/P); or alternatively: P=P₀e^{-z/cT} (1)

where c is a constant, T is the mean absolute (in Kelvin degrees) temperature, P is the pressure at altitude z, and Pₒ is the pressure at sea level. The constant c depends on the acceleration of gravity and the molar mass of the air.

FIG. 4 illustrates formula (1) for air pressure at height (h) above mean sea level.

In FIG. 4, the barometric pressure at sea level is depicted P₀, and the barometric pressure at altitude h is depicted Pₕ, so Pₕ=P₀ e^{-mgh/kT}. In FIG. 4, T is the absolute (Kelvin) mean temperature; the constant c in formula (1) is defined in FIG. 4 as k/mg, where k is Boltzmann's constant, g is the earth gravity acceleration and m is the air molecular weight (a.k.a. molar weight or molar mass) in amu (Atomic Mass Unit). As shown in FIG. 4, the average value of m for dry air is 29 amu.

So though a present art altimeter can read P quite accurately, at any altitude (z), it cannot determine P₀ by itself (unless placed at mean sea level), so cannot determine (z) easily.

Therefore, it is an object of the present invention to provide a method for altitude determination, based on altimeter measurements, yet avoid a troublesome manual calibration process.

It is further an object of the present invention to provide a method for altitude determination, particularly indoors.

It is still an object of the present invention to provide a method for indoors altitude determination, at least distinguishing between floors.

It is another object of the present invention to determine indoors altitude, by mobile devices typically carried by people, such as cellular phones, navigation devices and wrist watches.

It is then an object of the present invention to enable mobile devices to determine indoors altitude, avoiding deploying heavy infrastructure.

It is also an object of the present invention to provide a method for indoors positioning and navigation, based on standard communication networks.

Other objects and advantages of the invention will become apparent as the description proceeds.

### SUMMARY OF THE INVENTION

The invention is directed to a method for determining the altitude (z) of a point with known latitude (x) and known longitude (y) in a predefined geographical coordinate system, comprising the steps of:
a) defining a measurable parameter associated with the altitude;
b) measuring said parameter at point (x, y, z);
c) defining a reference altitude (z₀);
d) determining at a remote location said parameter associated with the position (x, y, z₀);
e) communicating said parameter associated with the position (x, y, z₀) to point (x, y, z);
f) determining the altitude (z) at point (x, y, z).

Preferably, said predefined geographical coordinate system is a Cartesian three dimensional coordinate system, centered substantially at the earth center, the z axis of this coordinate system substantially aligned with the earth rotation axis.

Preferably, said reference altitude (z₀) is mean sea level.

Alternatively, said reference altitude (z₀) is a floor level in a building, such as ground floor level or basement level.

Preferably, said parameter is the barometric pressure.

Preferably, said barometric pressure associated with the position (x, y, z₀) is acquired from a meteorological data base.

Alternatively, the barometric pressure associated with position (x, y, z₀) is determined by a barometer placed substantially nearby position (x, y).

According to a preferred embodiment of the present invention, a mobile phone, enabled with WIFI connectivity, and an embedded altimeter, is configured for determining its altitude (z) in a building, covered by a wireless LAN of WIFI type.

A server is installed nearby connected to that network, and a barometer is coupled to that server, and said server is configured to read said barometer and provide the reading in a digital form, to any authorized client accessing the server through the LAN. Furthermore, this stationary server records its altitude above mean sea level (configured upon installation), and knowing its altitude, as well as the dynamic barometric pressure reading, the server normalizes and publishes the present pressure for mean sea level (P₀), as derived from formula (1) defined in the background of the invention section. Alternatively, the server may publish the air pressure associated with its own altitude (or any other specific altitude), not necessarily mean sea level, yet indicate this altitude, so a client could take into account this altitude when considering the pressure published by the server.

Still according to the preferred embodiment of the present invention, the mobile device is configured to access said server and acquire P₀ which is determined and published by the server. The mobile device is also configured to access its internal altimeter (i.e. barometer) and read the barometric pressure (P). Then, employing said formula (1), the mobile device is configured to calculate its altitude (z) above mean sea level.

The invention is also directed to a system for determining the altitude (z) of a point with known latitude (x) and known longitude (y) in a predefined geographical coordinate system, comprised of a device configured to measure at said point a parameter associated with the altitude, and a remote station configured to determine said parameter associated with the position (x, y, z₀), wherein z₀ is a reference altitude, said remote station configured to communicate said parameter associated with the position (x, y, z₀) to said device, and said device configured to determine its altitude z.

Preferably for said system, said predefined geographical coordinate system is a Cartesian three dimensional coordinate system, centered substantially at the earth center, the z axis of this coordinate system substantially aligned with the earth rotation axis.

Preferably for said system, said reference altitude (z₀) is mean sea level.

Alternatively for said system, said reference altitude (z₀) is a floor level in a building, such as ground floor level or basement level.

Preferably for said system, said parameter is the barometric pressure.

Preferably for said system, said barometric pressure associated with the position (x, y, z₀) is acquired from a meteorological data base.

Alternatively for said system, the barometric pressure associated with position (x, y, z₀) is determined by a barometer placed substantially nearby position (x, y).

Preferably, said system is also configured to determine the latitude (x) and longitude (y) at said device, by means of said radio comprised in said device, or an additional GNSS receiver coupled to said controller comprised in said device.

When indoors, this may be done by measuring the TOA (Time of Arrival) of signals broadcast by two nearby reference stations, e.g., base stations or access points, assuming that these stations, as well as the detecting device, are on the same horizontal plane, wherein said signals accordingly report the position of those reference stations. As a person skilled in the art may appreciate, this can be done by resolving two Pythagorean equations, each equation representing a right angle triangle whose hypotenuse is the distance between the detecting device and one of those reference stations.

Preferably, said system is also configured to measure distance and direction of movement of said device, by means of an accelerometer or inertial sensor comprised in said device.

The invention is further directed to a device for determining the altitude (z) of a point with known latitude (x) and known longitude (y) in a predefined geographical coordinate system, comprising a controller a barometer and a radio, said device configured to determine the barometric pressure (P) at point (x, y, z), and communicate with a remote station which indicates the air pressure (P₀) by the position (x, y, z₀), and acquire P₀from said station, and determine its altitude z, wherein z₀ is a reference altitude.

Preferably for said device, said reference altitude (z₀) is mean sea level.

Alternatively for said device, said reference altitude (z₀) is a floor level in a building.

Preferably for said device, the barometric pressure by position (x, y, z₀) is acquired from a meteorological data base.

Alternatively for said device, the barometric pressure by position (x, y, z₀) is determined by a barometer placed substantially nearby position (x, y).

Preferably, said device is at least one of: navigation device or mobile phone or watch.

Preferably for said device, said radio is compatible with at least one of: Personal Area Network (PAN), Local Area Network (LAN), Wide Area Network (WAN).

Said device is configured also to determine its latitude (x) and longitude (y), by at least one of: said radio comprised in the device, or an additional GNSS receiver coupled to said controller.

This may be done even indoors, using the internal radio, by determining distance to radio stations whose position is known in advance or published via signals that said stations broadcast.

Optionally, the device is also configured to measure distance and direction of movement, by means of an accelerometer or inertial sensor. This enables “dead reckoning”, i.e. relative navigation.

The above examples and description have been provided for the purpose of illustration, and are not intended to limit the scope of the invention in any way. As will be appreciated by the skilled person, the invention can be carried out in a variety of ways, not limited by specific terms or specific interpretations of terms as described above, all without exceeding the scope of the invention.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 illustrates a coordinate system known in the art as ECEF (Earth Centered Earth Fixed). The X axis and Y axis are shown on the equatorial plane and the Z axis is perpendicular to the equatorial plane and passes through the North Pole. The X axis is also shown crossing the equator at the prime meridian. A point (φ, π, z) above earth surface is shown, perpendicular to a rectangle tangential to the earth surface. According to that coordinate system, this point is at latitude φ, longitude X and altitude z.

FIG. 2 illustrates a System for determining the Altitude of a Mobile Device according to a 1^{st} embodiment of the present invention. A mobile device is shown, comprising a wireless LAN client, such as WIFI radio, a controller and a first altimeter, and optionally also a thermometer (shown in dashed lines). The mobile device is shown to be at altitude (z) above mean sea level (the latter indicated as altitude z₀). A wireless LAN is illustrated by a cloud, enabling connectivity between said LAN client and an Access Point. A server is shown coupled to said access point, and a second altimeter coupled to said server. The server is shown at altitude (zₛ) above mean sea level.

FIG. 3 illustrates a System for determining the Altitude of a Mobile Device according to a 2^{nd} embodiment of the present invention. A mobile device is shown, comprising a cellular radio, such as GSM or CDMA or LTE (4G) radio, a controller and a barometer. The mobile device is shown to be at altitude (z) above mean sea level (mean sea level indicated as altitude z₀). A cellular WAN is illustrated by a cloud, enabling connectivity between said cellular radio and a Base Station. A Meteorological server is shown coupled to said base station.

FIG. 4 illustrates the air pressure at height (h) above mean sea level. In FIG. 4, the barometric pressure at sea level is depicted P₀, and the barometric pressure at altitude h is depicted Pₕ=P₀ e^{-mgh/kT}. In FIG. 4, T is the absolute (Kelvin) mean temperature; the constant c in formula (1) is defined in FIG. 4 as k/mg, where k is Boltzmann's constant, g is the earth gravity acceleration and m is the air molecular weight (a.k.a. molar weight or molar mass) in amu (Atomic Mass Unit). As shown in FIG. 4, the average value of m for dry air is 29 amu.

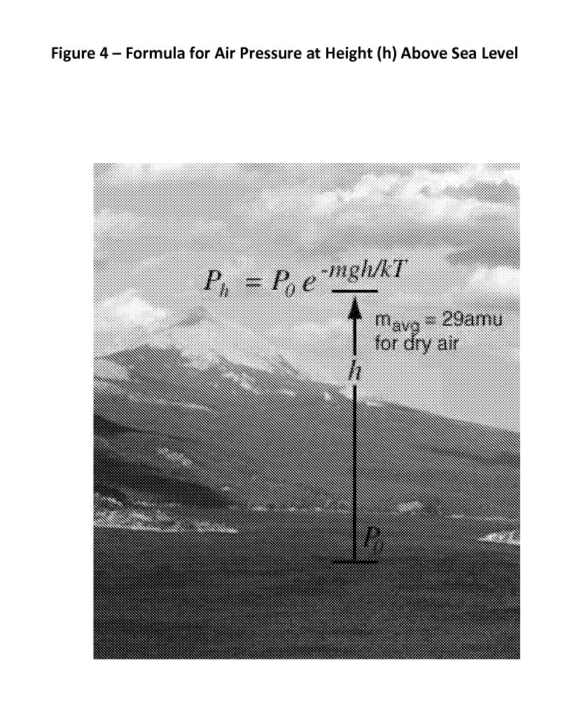

FIG. 5 illustrates a Synoptic Barometric Map and Temperature Map. The Synoptic barometric map is at the upper part of the picture and the temperature map is at the lower part of the picture. Both maps show on the background a geographical map of the USA and on top of that background, the barometric map indicates the air pressure, by means of isobars, and the temperature map indicates the temperature, by means of colored areas. Each isobar drawn on the map joins places of equal average atmospheric pressure reduced to sea level (for a specified period of time) and each color on the temperature map indicates a specific temperature range. The units used to define the air pressure in FIG. 5 are millibars, and the temperatures are defined in two scales: Celsius (C) and Fahrenheit (F). As a person skilled in the art appreciates, 1013.35 millibars=1 atmosphere, so a Low pressure of 992 millibars is shown near Chicago and a High pressure of 1024 is depicted in Idaho. For Miami, placed in FIG. 5 between 1016 millibar isobar to 1020 millibar isobar, an average barometric pressure of 1018 is preferably chosen. The temperature in Miami is about 27° C., according to the map in FIG. 5.

FIG. 6 illustrates a Navigation Device for determining the Altitude according to a 5^{th} embodiment of the present invention. The device is comprised of: a controller, coupled to a cellular radio and to a barometer. The controller is further coupled to a thermometer, an accelerometer (inertial sensor) and to a GPS receiver.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

The invention is directed to a method for determining the altitude (z) of a point with known latitude (x) and known longitude (y) in a predefined geographical coordinate system, comprising the steps of:
a) defining a measurable parameter associated with the altitude;
b) measuring said parameter at point (x, y, z);
c) defining a reference altitude (z₀);
d) determining at a remote location said parameter associated with the position (x, y, z₀);
e) communicating said parameter associated with the position (x, y, z₀) to point (x, y, z);
f) determining the altitude (z) at point (x, y, z).

Preferably, said predefined geographical coordinate system is an ECEF (Earth Centered Earth Fixed) Cartesian three dimensional coordinate system, based on the WGS84 geodetic model, as employed by the GPS.

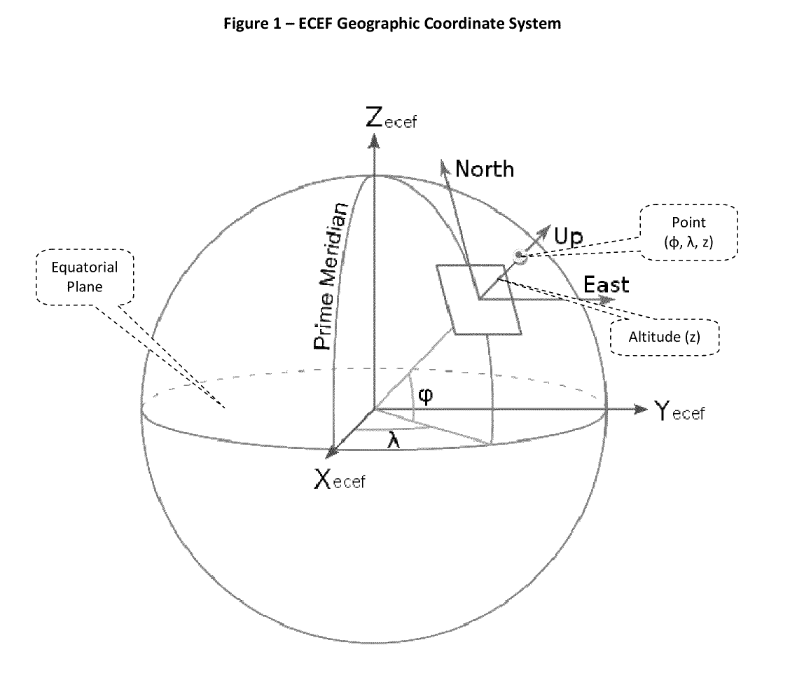

FIG. 1 illustrates a coordinate system known in the art as ECEF (Earth Centered Earth Fixed). The X axis and Y axis are shown on the equatorial plane and the Z axis is perpendicular to the equatorial plane and passes through the North Pole. The X axis is also shown crossing the equator at the prime meridian. A point (φ, λ, z) above earth surface is shown, perpendicular to a rectangle tangential to the earth surface. According to that coordinate system, this point is at latitude φ, longitude X and altitude z.

Preferably, said reference altitude (z₀) is mean sea level.

Alternatively, said reference altitude (z₀) is a floor level in a building, such as ground floor level or basement level.

Preferably, said parameter is the barometric pressure.

Preferably, the barometric pressure associated with position (x, y, z₀) is acquired from a meteorological data base.

Alternatively, the barometric pressure associated with position (x, y, z₀) is determined by a barometer placed substantially nearby position (x, y).

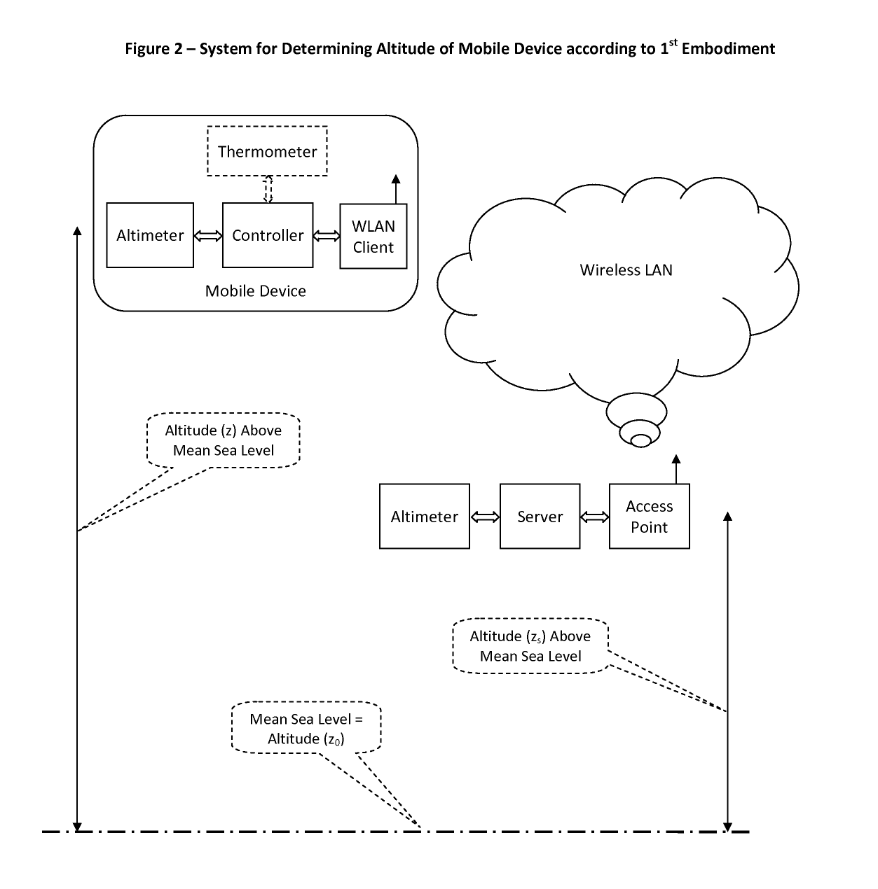

FIG. 2 illustrates a System for determining the Altitude of a Mobile Device according to a 1^{st} embodiment of the present invention. A mobile device is shown, comprising a wireless LAN client, such as WIFI radio, a controller and a first altimeter, and optionally also a thermometer (shown in dashed lines). The mobile device is shown to be at altitude (z) above mean sea level (the latter indicated as altitude z₀). A wireless LAN is illustrated by a cloud, enabling connectivity between said LAN client and an Access Point. A server is shown coupled to said access point, and a second altimeter coupled to said server. The server is shown at altitude (zₛ) above mean sea level.

According to the 1^{st} embodiment of the present invention, the server is configured to read the barometric pressure (Pₛ), from said second altimeter. Knowing its altitude (zₛ) above mean sea level, which is configured to said server upon installation, the server is configured to employ formula (1) and determine: P₀=Pₛ e^{zs/cT} and publish P₀, which is the barometric pressure at its position however normalized to mean sea level. At the mobile device, the controller is configured to read the barometric pressure (P), from said first altimeter, and access the server to acquire P₀. Then, employing formula (1), the mobile device is configured to determine its altitude above mean sea level: z=c T log (P₀/P).

It's interesting to see that z=c T log(P₀/P)=c T log (Pₛ/P)+zₛ

So the server may either publish P₀ or Pₛ and zₛ.

As a skilled person may observe, the mobile device requires to know also T, the mean absolute temperature (Kelvin), in order to determine its altitude. For determining the temperature, the mobile device may be configured also with a thermometer, as shown in FIG. 2, or alternatively acquire the temperature from the server. Another practical (yet less accurate) alternative is to assess the mean temperature according to statistical data or even assume a constant temperature, e.g. 288° K (about 15° C.). Analyzing formula (1), a skilled person may appreciate that an error of 3° in the temperature (either Kelvin or Celsius) causes an error of about 1% in altitude determination. For example, considering a 100 meters height building, in NYC (about 300 meters above mean sea level), the error of determining the altitude of a device in that building can be 3-4 meters (i.e. a floor) per 3° C.

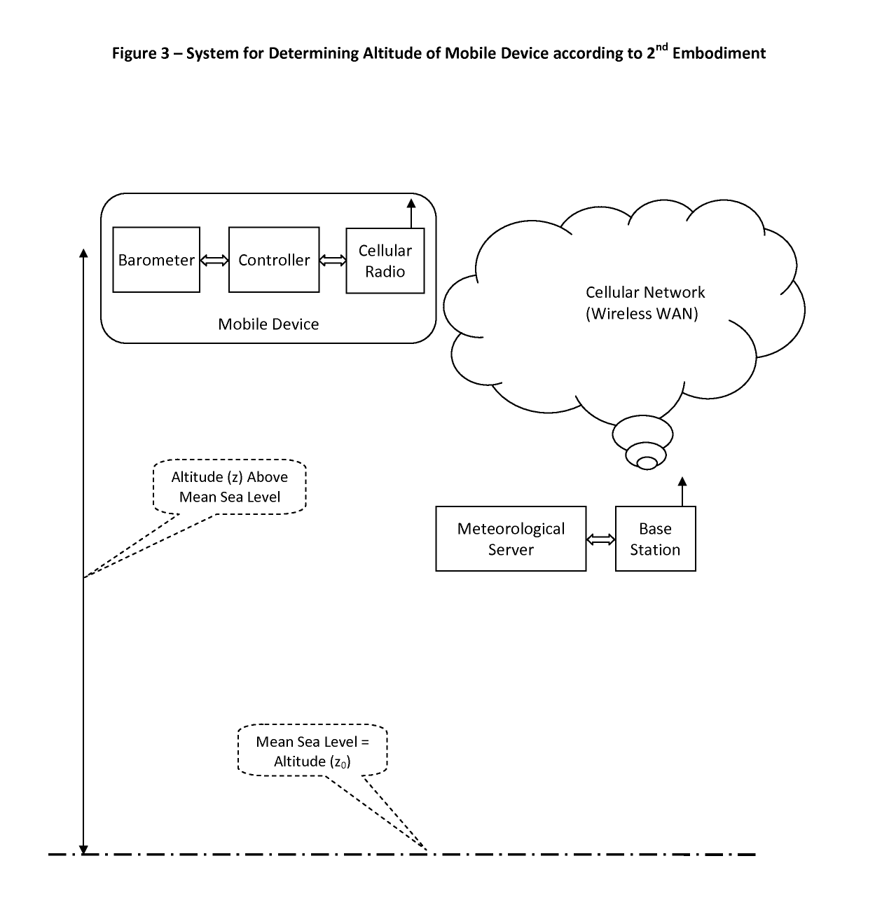

FIG. 3 illustrates a System for determining the Altitude of a Mobile Device according to a 2^{nd} embodiment of the present invention. A mobile device is shown, comprising a cellular radio, such as GSM or CDMA or LTE (4G) radio, a controller and a barometer. The mobile device is shown to be at altitude (z) above mean sea level (the latter indicated as altitude z₀). A cellular WAN is illustrated by a cloud, enabling connectivity between said cellular radio and a Base Station. A Meteorological server is shown coupled to said base station.

According to the 2^{nd} embodiment of the present invention, the meteorological server is configured with a synoptic barometric map, in a digital format, indicating the barometric pressure at mean sea level over a wide area, and particularly the barometric pressure (P₀) nearby the position (x, y) of the mobile device. Said Meteorological server also comprises a temperature map, also in digital format, indicating the temperature per specific area. Both maps are dynamic, i.e. indicate pressure and temperature per specific time, as well as per specific area.

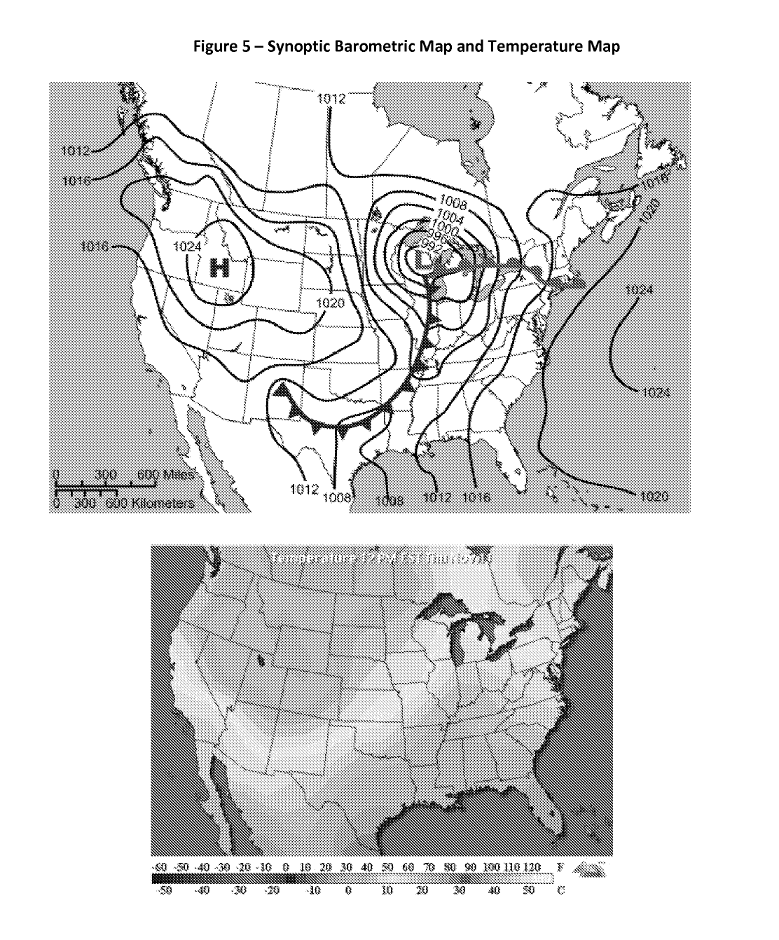

FIG. 5 illustrates a Synoptic Barometric Map and Temperature Map. The Synoptic barometric map is at the upper part of the picture and the temperature map is at the lower part of the picture. Both maps show on the background a geographical map of the USA and on top of that background, the barometric map indicates the air pressure, by means of isobars, and the temperature map indicates the temperature, by means of colored areas. Each isobar drawn on the map joins places of equal average atmospheric pressure reduced to sea level (for a specified period of time) and each color on the temperature map indicates a specific temperature range (also for a specified period of time). The units used to define the air pressure in FIG. 5 are millibars, and the temperatures are defined in two scales: Celsius (C) and Fahrenheit (F). As a person skilled in the art appreciates, 1013.35 millibars=1 atmosphere, so a Low pressure of 992 millibars is shown near Chicago and a High pressure of 1024 is depicted in Idaho. For Miami, placed in FIG. 5 between the 1016 millibar isobar to the 1020 millibar isobar, an average barometric pressure of 1018 is preferably chosen. The temperature in Miami is about 27° C., according to the map in FIG. 5.

A mobile device according to the 2^{nd} embodiment of the present invention, is configured to determine its coarse position (e.g. by Cell ID—identify a nearby cellular base station and determine its own position according to a data base associating CELL ID with a geographical location, or decoding a position message broadcast by that base station) then read the barometric pressure (P₀) associated with that position from the meteorological server, and the mean temperature T published by the server, as illustrated in FIG. 5. For example, if said mobile device is in the vicinity of Miami, it reads P₀=1018, corresponding to the interpolation of 1016 and 1020 isobars which Miami is in between, and T=27° C.

Still according to the 2^{nd} embodiment of the present invention, the mobile device is configured to read the barometric pressure (P), from its built-in barometer, as shown in FIG. 3, and acquiring also (P₀) and (T) from the server, the mobile device is configured to determine its altitude above mean sea level employing formula (1): z=c T log (P₀/P).

The invention is also directed to a system for determining the altitude (z) of a point with known latitude (x) and known longitude (y) in a predefined geographical coordinate system, comprised of a device configured to measure at said point a parameter associated with the altitude, and a remote station configured to determine said parameter associated with the position (x, y, z₀), wherein z₀ is a reference altitude, said remote station configured to communicate said parameter associated with the position (x, y, z₀) to said device, and said device configured to determine its altitude z.

Preferably for said system, said predefined geographical coordinate system is an ECEF (Earth Centered Earth Fixed) Cartesian three dimensional coordinate system, based on the WGS84 geodetic model, as employed by the GPS.

Preferably for said system, said reference altitude (z₀) is mean sea level.

Alternatively for said system, said reference altitude (z₀) is a floor level in a building, such as ground floor level or basement level.

Preferably for said system, said parameter is the barometric pressure.

Preferably for said system, the barometric pressure associated with position (x, y, z₀) is acquired from a meteorological data base.

Alternatively for said system, the barometric pressure associated with position (x, y, z₀) is determined by a barometer placed substantially nearby position (x, y).

Preferably, said system is also configured to determine the latitude (x) and longitude (y) at said device, by means of said radio comprised in said device, or an additional GNSS receiver coupled to said controller comprised in said device.

According to a preferred embodiment of the present invention, the device is configured to measure the TOA (Time of Arrival) of signals broadcast by three (or more) nearby reference stations, either LAN or WAN compatible, wherein said stations broadcast also their exact position coordinates. By resolving the three (or more) pseudorange equations, as known in the art in the context of GPS positioning, the device is configured to calculate its own position coordinates (x, y, z). Then, using the altitude (z) determined by resolving formula (1), based on the barometric pressure measurement, the device is configured to refine its position, employing methods known in the art as Kalman filtering or Least Squares.

Preferably, said system is also configured to measure distance and direction of movement, by means of an accelerometer or inertial sensor comprised in said device.

The invention is further directed to a device for determining the altitude (z) of a point with known latitude (x) and known longitude (y) in a predefined geographical coordinate system, comprising a controller a barometer and a radio, said device configured to determine the barometric pressure (P) at point (x, y, z), and communicate with a remote station which indicates the air pressure (P₀) by the position (x, y, z₀), and acquire P₀from said station, and determine its altitude z, wherein z₀ is a reference altitude.

Preferably for said device, said reference altitude (z₀) is mean sea level.

Alternatively for said device, said reference altitude (z₀) is a floor level in a building.

Preferably for said device, the barometric pressure by position (x, y, z₀) is acquired from a meteorological data base.

Alternatively for said device, the barometric pressure by position (x, y, z₀) is determined by a barometer placed substantially nearby position (x, y).

Preferably, said device is at least one of: navigation device or mobile phone or watch.

Preferably for said device, said radio is compatible with at least one of: Personal Area Network (PAN), Local Area Network (LAN), Wide Area Network (WAN).

Said device is configured also to determine its latitude (x) and longitude (y), by at least one of: said radio comprised in the device, or an additional GNSS receiver coupled to said controller.

Optionally, the device is also configured to measure distance and direction of movement, by means of an accelerometer or inertial sensor.

According to a 3^{rd} embodiment of the present invention, a navigation device is installed in a car, implemented as the mobile device in FIG. 2 or FIG. 3, but additionally embedded with a GPS receiver. When entering an underground parking lot, this mobile device is configured to access a server as depicted in FIG. 2 or FIG. 3, to acquire the barometric pressure P₀ at mean sea level at the latitude and longitude of this underground parking lot. The latitude and longitude of the parking lot is assessed by said navigation device according to its last position fix, acquired outdoors just before moving underground. In addition to the barometric pressure, the navigation device acquires also the temperature from said server. Measuring the barometric pressure (P) at the parking lot, and acquiring the barometric pressure at mean sea level (P₀) and the mean temperature (T), the navigation device is configured to determine its altitude (z) above mean sea level: z=c T log (P₀/P). Upon parking, the navigation device user may record its altitude, and navigate back to that place. Furthermore, employing an additional inertial sensor, the device can be set to measure the distance and direction from the parked car to the elevator, and afterwards navigate back to the car.

According to a 4^{th} embodiment of the present invention, a location device is installed on a minor's helmet, implemented as the mobile device in FIG. 2. When entering an underground mine, this mobile device is configured to access a server as depicted in FIG. 2, and report its barometric pressure (P). The server is configured to determine the barometric pressure P₀ at mean sea level at the latitude and longitude of the mine, and also the mean temperature (T). Then, the server is configured to determine the minor's altitude (z) above mean sea level: z=c T log (P₀/P).

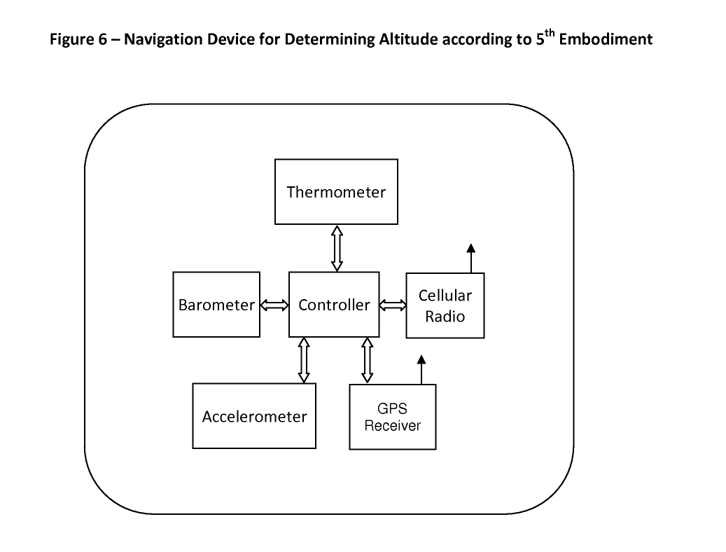

FIG. 6 illustrates a Navigation Device for determining the Altitude according to a 5^{th} embodiment of the present invention. The device is comprised of: a controller, coupled to a cellular radio and to a barometer. The controller is further coupled to a thermometer, an accelerometer (inertial sensor) and to a GPS receiver.

According to the 5^{th} embodiment of the present invention, the navigation device depicted in FIG. 6 is carried by a person who wishes to navigate to a specific store or office in a high building, whose coordinates are configured into the device and define a way point. Once the person enters the building, the GPS receiver does not update its position any more, since the satellites signals are blocked, and then the inertial sensor is initialized. The user then activates the altitude determination application, which operates similarly to the 3^{rd} embodiment of the invention, based on FIG. 2. In this case, the last position acquired by the GPS receiver is used as an entry to the barometric pressure data base published by the server. While constantly measuring its altitude, the user navigates (up and down the stairs/elevator) until his/her altitude is similar to the desired target altitude. At this phase, knowing that he/she are at the right level, the user navigates to the desired latitude and longitude, based on the inertial sensor measurements.

The above examples and description have been provided for the purpose of illustration, and are not intended to limit the scope of the invention in any way. As will be appreciated by the skilled person, the invention can be carried out in a variety of ways, not limited by specific terms or specific interpretations of terms as described above, all without exceeding the scope of the invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

The invention claimed is:

1. A method for determining the altitude (z) of a point with known latitude (x) and known longitude (y) in a predefined geographical coordinate system, comprising the steps of:
a) defining a measurable parameter associated with the altitude;
b) measuring said parameter at point (x, y, z);
c) defining a reference altitude (z₀);
d) determining at a remote location said parameter associated with the position (x, y, z₀);
e) communicating said parameter associated with the position (x, y, z₀) to point (x, y, z);
f) determining the altitude (z) at point (x, y, z).

2. A method according to claim 1, wherein said reference altitude (z₀) is mean sea level.

3. A method according to claim 1, wherein said parameter is the barometric pressure.

4. A method according to claim 3, wherein the barometric pressure associated with position (x, y, z₀) is determined by a barometer placed substantially nearby position (x, y).

5. A method according to claim 3, wherein the barometric pressure associated with position (x, y, z₀) is acquired from a meteorological data base.

6. A system for determining the altitude (z) of a point with known latitude (x) and known longitude (y) in a predefined geographical coordinate system, comprised of a device configured to measure at said point a parameter associated with the altitude, and a remote station configured to determine said parameter associated with the position (x, y, z₀), wherein z₀ is a reference altitude, said remote station configured to communicate said parameter associated with the position (x, y, z₀) to said device, and said device configured to determine its altitude z.

7. A system according to claim 6, wherein said reference altitude (z₀) is mean sea level.

8. A system according to claim 6, wherein said parameter is the barometric pressure.

9. A system according to claim 8, wherein the barometric pressure associated with position (x, y, z₀) is determined by a barometer placed substantially nearby position (x, y).

10. A system according to claim 8, wherein the barometric pressure associated with position (x, y, z₀) is acquired from a meteorological data base.

11. A system according to claim 6, configured also to determine latitude (x) and longitude (y) at said device, by means of: said radio comprised in the device, or an additional GNSS receiver coupled to said controller comprised in said device.

12. A system according to claim 6, configured also to measure distance and direction of movement at said device, by means of an accelerometer or inertial sensor comprised in said device.

13. A device for determining the altitude (z) of a point with known latitude (x) and known longitude (y) in a predefined geographical coordinate system, comprising a controller a barometer and a radio, said device configured to determine the barometric pressure (P) at point (x, y, z), and communicate with a remote station which indicates the air pressure (P₀) by the position (x, y, z₀), and acquire P₀ from said station, and determine its altitude z, wherein z₀ is a reference altitude.

14. A device according to claim 13, wherein said reference altitude (z₀) is mean sea level.

15. A device according to claim 13, wherein the barometric pressure by position (x, y, z₀) is determined by a barometer placed substantially nearby position (x, y).

16. A device according to claim 13, wherein the barometric pressure by position (x, y, z₀) is acquired from a meteorological data base.

17. A device according to claim 13, at least one of: navigation device or mobile phone or watch.

18. A device according to claim 13, wherein said radio is compatible with at least one of: Personal Area Network (PAN), Local Area Network (LAN), Wide Area Network (WAN).

19. A device according to claim 13, configured also to determine its latitude (x) and longitude (y), by means of at least one of: said radio comprised in the device, or an additional GNSS receiver coupled to said controller.

20. A device according to claim 13, configured also to measure distance and direction of movement, by means of an accelerometer or inertial sensor.
